(19) United States
(12) Patent Application Publication
(10) Pub. No.: US 2008/0181312 A1
(43) Pub. Date: Jul. 31, 2008

(54) Television receiver apparatus and a frame-rate converting method for the same

(75) Inventor: Katsunobu Kimura, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Ltd., Tokyo (JP)

(21) Appl. No.: 12/002,949

(22) Filed: Dec. 18, 2007

(30) Foreign Application Priority Data
Dec. 25, 2006 (JP) 2006-348385

(51) Int. Cl. H04N 7/24

(52) U.S. Cl. 375/240.27; 375/E07.002

(57) ABSTRACT

For providing television receiver apparatus and a video displaying method for that, i.e., suppressing deterioration of picture quality when conducting a frame-rate conversion on a video signal while piling up an OSD picture thereon, within the television receiver apparatus, picture quality correction is made on an input video signal including the moving picture therein. After inserting the OSD picture within an OSD inserter (OSD processor) unit 8, a frame-rate conversion is conducted within a frame-rate converter unit 9. Further, the frame-rate converter unit executes a frame-rate conversion accompanying a moving picture frame interpolation therewith, upon the video signal including the moving picture therein within a screen of one (1) frame to be displayed, while it executes a frame-rate conversion accompanying no moving picture frame interpolation therewith, upon the OSD picture, and thereby displaying the video signal including the moving picture therein on a display panel 10, together with the OSD picture, while conducting frame interpolation thereupon.

### BACKGROUND OF THE INVENTION

The present invention relates to a video displaying technology for a television receiver, and it also relates, in particular, to a television receiver apparatus and a video displaying method for the same, for the purpose of preventing pictures from being deteriorated in the quality thereof, in case when displaying a stationary or still picture, such as, letters or characters, for example, lying or piling them on a moving picture.

Conventionally, within a television receiver apparatus for enabling to receive digital broadcasts or the like, for example, with aiming an improvement in the picture quality thereof, it is already known to conduct a frame-rate conversion upon a video signal, with using a motion vector (i.e., increasing the number of frames), and thereby to achieve a video display as the moving picture with smooth changes, through conducting a frame interpolation thereon.

For example, in the following Patent Document 1, as the conventional technology for conducting the frame interpolation through the frame-rate conversion, and in particular, as the frame-rate conversion technology for enabling a display of picture with high picture quality while smoothing the motion of the picture, it is described that detection is made on the motion vector of the moving picture, so as to determine direction of the interpolation, with using information of a first frame, which appears at time prior to an interpolation frame, a second frame, which appears at time prior to the said first frame, a third frame, which appears at time subsequent to the insertion time, and also further a fourth frame, which appears at time subsequent to the said third frame, upon basis of the timing of insertion of the interpolation frame, and an interpolation frame is generated, by producing interpolation pixels from the pixels of the second frame and the third frame lying in the said interpolation direction determined, and thereby inserting it into an input video signal.

On the other hand, since a television receiver apparatus applies OSD (On Screen Display) display, widely, by means of a stationary or still picture, including characters and diagrams, etc., for achieving an introduction of broadcast programs, as well as, various kinds of functions and operations of that apparatus, and for that reason, therefore, there are many cases when displaying the still picture while putting it on the moving picture mentioned above.

[Patent Document 1] Japanese Patent Laying-Open No. 2006-165602 (2006)

As was mentioned above, in case when displaying the still picture piling on the moving picture, in particular, when conducting a frame-rate conversion process upon the video signal, which is obtained by piling up the still picture on the said moving picture, noises are generated on the OSD picture, i.e., the still picture, and in particular, on the boundary portion thereof, and there bring about a drawback of deterioration on the picture quality.

### BRIEF SUMMARY OF THE INVENTION

Then, according to the present invention, accomplished by taking the drawback within the conventional art mentioned above into the consideration thereof, and namely, an object of the present invention is to provide a television receiver apparatus and a video displaying method for the same, without deteriorating the quality of pictures displayed thereon, when displaying the still picture, such as, characters, etc., i.e., the OSD picture, piling on the moving picture.

However, the generation of noises on a boundary portion of the OSD picture, within the picture after conducting the frame-rate conversion process thereon, according to the study made by the inventors of the present invention, can be considered that, it is caused due to the fact that a FRC process is conducted on a part of the still picture due to the frame-rate conversion, i.e., being drawn or influenced with the motion of the moving picture behind that, in particular, in the boundary portion between the OSD picture, where the still picture and the moving picture are mixed up with.

Thus, the present invention is accomplished upon basis of the acknowledgement made by the inventors of the present invention, and in more details thereof, for the purpose of achieving the objection mentioned above, firstly of all, there is provided a television receiver apparatus, for interpolating a video signal including moving picture therein, and thereby displaying a picture together with an OSD picture thereon, comprising: a picture quality corrector unit, which is configured to correct picture quality of an input video signal including the moving picture therein; an ODS picture inserting unit, which is configured to insert the OSD picture into the video signal, including the moving picture therein, which is supplied from said picture quality corrector unit; a frame-rate converter unit, which is configured to conduct a frame-rate conversion upon the video signal including the moving picture therein, being outputted from said OSD picture inserter unit, into which the OSD picture is inserted; and a display unit, which is configured to display the video signal outputted from said frame-rate converter unit, wherein said frame-rate converter unit executes a frame-rate conversion accompanying a moving picture frame interpolation therewith, upon the video signal including the moving picture therein within a screen of one (1) frame to be displayed, while it executes a frame-rate conversion accompanying no moving picture frame interpolation therewith, upon said OSD picture.

Also, according to the present invention, within the television receiver apparatus, as described in the above, it is preferable that said frame-rate converter unit comprises a first converter unit, which is configured to execute said frame-rate conversion accompanying the moving picture frame interpolation therewith, a second converter unit, which is configured to execute said frame-rate conversion accompanying no moving picture frame interpolation therewith, and an exchanger unit, which is configured to selectively control an output from said first converter unit or an output from said second converter unit, corresponding to a picture portion including the moving picture therein on said screen of one (1) frame to be displayed and position information of said ODS picture, and further comprises a controller unit, which is configured to control said exchanger unit of said frame-rate converter unit, wherein said controller unit comprises a memory memorizing the position information of said OSD picture.

Further, according to the present invention, also for accomplishing the object mentioned above, there is further provided a television receiver apparatus, for interpolating a video signal including moving picture therein, and thereby displaying a picture together with a still picture thereon, comprising: a picture quality corrector unit, which is configured to correct picture quality of an inputted video signal, including the moving picture therein; a frame-rate converter unit, which is configured to conduct a frame-rate conversion upon the video signal including the moving picture therein, being outputted from said picture quality corrector unit; and a display unit, which is configured to display the video signal outputted from said frame-rate converter unit, further comprising an OSD picture inserter unit, which is configured to insert an OSD picture into a portion of the video signal including the moving picture therein, being outputted from said frame-rate converter unit, into which the still picture is inserted.

In addition to the above, according to the present invention, also for accomplishing the object mentioned above, there is further provided a frame-rate converting method within a television receiver apparatus for interpolating a video signal including moving picture therein, and thereby displaying a picture together with a still picture thereon, comprising the following steps of: conducting a picture quality correction for correcting picture quality of an input video signal including moving picture therein; inserting an OSD picture into the video signal including the moving picture therein, upon which the picture quality correction is conducted; and conducting a frame-rate conversion upon the video signal including the moving picture therein, into which said OSD picture is inserted, wherein a frame-rate conversion accompanying a moving picture frame interpolation therewith is conducted upon the video signal including the moving picture therein within a screen of one (1) frame to be displayed, while a frame-rate conversion accompanying no moving picture frame interpolation therewith is conducted upon said OSD picture.

And, also, for accomplishing the object mentioned above, according to the present invention, there is further provided a frame-rate converting method within a television receiver apparatus for interpolating a video signal including moving picture therein, and thereby displaying a picture together with a still picture thereon, comprising the following steps of: conducting a picture quality correction for correcting picture quality of an input video signal including moving picture therein; conducting a frame-rate conversion upon said video signal including the moving picture therein, upon which said picture quality correction is conducted; and inserting an OSD picture into the video signal including the moving picture therein, upon which said frame-rate conversion is conducted, whereby displaying the video signal including the moving picture therein, into which said OSD picture is inserted, on a display unit.

Thus, according to the present invention mentioned above, since no such frame-rate process will be conducted on a portion of the OSD picture, due to the frame-rate conversion, i.e., being drawn or influenced with the motion of the moving picture behind that, on the boundary portion between the still picture (i.e., the OSD picture) and the moving picture, and therefore, it is possible to suppress the generation of noises in the boundary portion of the OSD picture, on the picture after conducting the frame-rate conversion process thereon. With this, there can be achieved a superior effect, i.e., enabling to provide a television receiver apparatus and a video displaying method for the same, being superior in display performances thereof, but without deteriorating the picture quality even when displaying the moving picture while piling the OSD picture, such as, the characters or the like, thereon.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing the outlook structures of a television receiver apparatus, according to an embodiment of the present invention;

FIG. 2 is a view for explaining a frame-rate converting operation after conducting an OSD process, within the television receiver apparatus mentioned above;

FIG. 3 is a view for showing an example of a video display, including an OSD display, within the television receiver apparatus mentioned above;

FIG. 4 is a block diagram for showing the outlook structures of a television receiver apparatus, according to another embodiment of the present invention; and

FIG. 5 is a view for showing an example of operation of an normal frame-rate converter unit.

### DETAILED DESCRIPTION OF THE PREFERRED EMBODIMENTS

Hereinafter, embodiments according to the present invention will be fully explained by referring to the attached drawings.

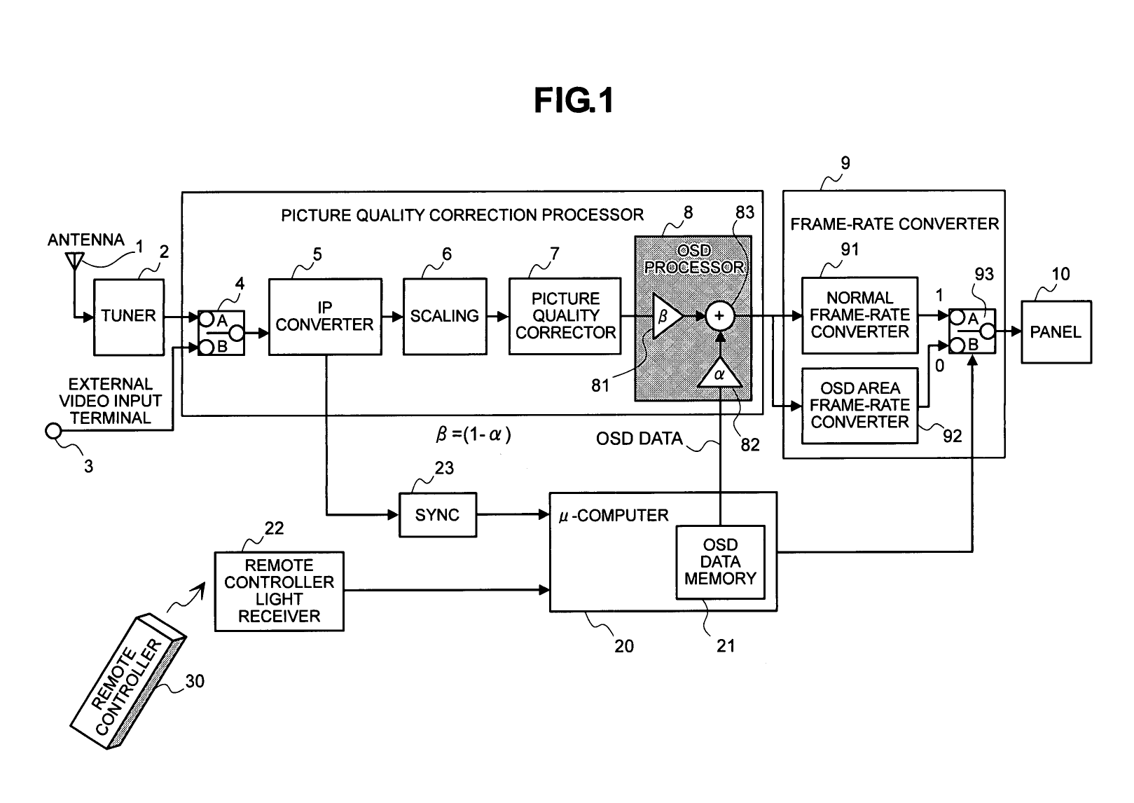

First of all, FIG. 1 attached herewith is a block diagram for showing the entire structures of a television receiver apparatus, according to an embodiment of the present invention.

In this FIG. 1, a broadcast video signal, such as, a digital broadcast signal, etc., for example, is received by an antenna 1, and it is inputted into an exchanger unit 4 through a tuner 2. On the other hand, into this exchanger unit 4 is further inputted a video signal from an external equipment, such as, a distribution information, etc., through an external video input terminal 3; i.e., within this exchanger unit 4, either the broadcast video signal supplied from the antenna 1 or the video signal supplied from the external video input terminal 3 is selected. However, herein, explanation will be made upon assumption that the broadcast video signal received by the antenna 1 is selected within the exchanger unit 4.

Thus, the broadcast signal mentioned above is inputted into an I/P conversion unit 5, further, and within the said I/P conversion unit 5, the I/P conversion is conducted therein, and thereby being converted into a video signal of sequential scan (i.e., P scan). Next, this video signal is inputted into a scaling unit 6, and within the said scaling unit 6, the resolution power thereof is converted, i.e., into the resolution power being larger than that of a display panel 10, as a display unit. For example, in case where the display panel 10 is a high-vision (i.e., high-definition (HD) television) having the resolution power 1,920 in the horizontal direction and the resolution power 1,080 in the vertical direction, and the broadcast video signal inputted into the scaling unit 6 has also the resolution powers, i.e., 1,920 in the horizontal direction and the resolution 1,080 in the vertical direction, then the broadcast video signal is converted in the resolution thereof, within the scaling unit 6, i.e., into the resolution power 1,920+A (A>0) in the horizontal direction and the resolution power 1,080+B (B>0). However, herein, those A and B are values, each being equal to or less than around 5%. For example, if the resolution power of the panel is 1,920 in the horizontal direction, then the value of “A” is equal to 96 or lower than that, and if the resolution power of the panel is 1,080 in the vertical direction, then the value of “B” is equal to 54 or lower than that. Preferably, the values of “A” and “B” are within a range from 5 to several tens. Thus, when detecting the video format of the video signal, the scaling unit 6 is so controlled, upon basis of the resolution conversion information, which is preset corresponding to the said video formats, that the resolution powers of the video signal are 1,920+A in the horizontal direction and 1,080+B in the vertical direction.

The video signal converted in the resolution powers thereof in this manner is inputted into a picture quality corrector unit 7, next, and within the said picture quality corrector unit 7 is conducted the picture quality correction thereon, such as, gamma correction and/or color correction, etc. To the video signal, upon which this picture quality correction is treated, within an OSD processor unit 8) is further inserted data necessary for SCD (On Screen Display), i.e., so as to introduce the broadcast programs and/or to enable to conduct various kinds of functions and/or operations of the apparatus (hereinafter, being called “OSD screen”). Thus, within this OSD processor unit 8 are added (or, oiled up) the video signal from the picture quality corrector unit 7, amplitude of which is amplified by “β” times through an amplifier 81, and OSD data (i.e., still picture), amplitude of which is amplified by “α” times through an amplifier 82, by an adder 83. Further, this OSD data (i.e., still picture) is outputted from an OSD data memory 21, provided in a part of a microcomputer (μ-computer) 20 for controlling that television receiver apparatus, and for storing data (OSD data) in apart thereof, which is necessary for the OSD (On Screen Display), including characters and diagrams, etc., and “α” and “β” mentioned above are in the relationship, i.e., β=1−α; 0≦α≦1). Also, as is apparent from the figure, it is clear for a person skilled in the art that an optical control signal, such as, an infrared ray or the like, which is emitted from a remote controller 30 for operating the television receiver apparatus, is received upon a remote controller light receiver unit 22, so that the μ-computer 20 mentioned above inputs it therein, and thereby achieving a predetermined control.

Thereafter, the signal supplied from a picture quality correct processor unit, being made in the form of an IC (Integrated Circuit) including the I/P conversion unit 5, the scaling unit 6, the picture quality corrector unit 7, and the OSD process unit 8, mentioned above, it is further inputted into a frame-rate converter unit 9, and within the said frame-rate converter unit 9 is conducted the frame-rate conversion on it, i.e., achieving the frame-rate interpolation. And, according to one embodiment of the present invention, the said frame-rate converter unit 9 is built up with a normal frame-rate converter unit 91, thus, for conducting an ordinary or normal frame-rate conversion on the video signal, an OSD area frame-rate converter unit 92, on the other hand, for conducting the frame interpolation on a still picture, and further an exchanger unit 93, which is made up with a switch for exchanging an output from those two (2) converters. In more details thereof, within the normal frame-rate converter unit 91 mentioned above, the frame-rate conversion with using a motion vector is conducted on the video signal from the above picture quality correct processor unit, in particular, upon a moving picture portion thereof, i.e., conducting the frame interpolation including the motion of the moving picture (i.e., a moving picture frame interpolation), and thereby obtaining a moving picture with smooth changes. On the other hand, within the OSD area frame-rate converter unit 92, the frame conversion is conducted upon the OSD picture, which is piled on the video signal within the OSD processor unit 8 mentioned above. Thus, without conducting the frame interpolation, including movement therein (i.e., a still picture frame interpolation), the frame is repeated, as a still picture.

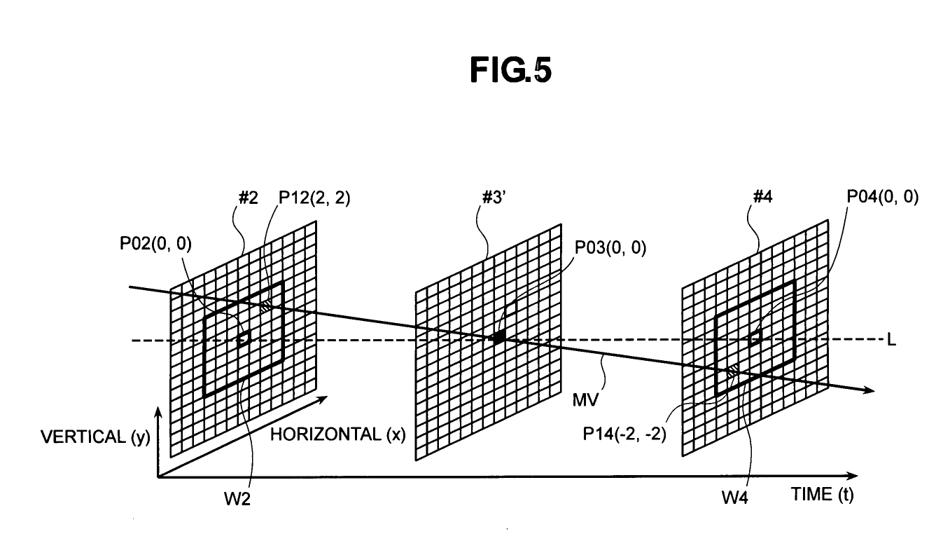

Herein, the normal frame-rate converter unit 91 produces an interpolation frame to be inserted into the frame lines of the video signal, from at least two (2) frames, which are included in the video signal. For example, a motion vector of attention pixels of the interpolation frame is detected from the two (2) frames of the video signal, putting or holding that interpolation frame between them, and then a filtering process (i.e., a weighted average) is conducted upon the pixels of two (2) frames, which are designated by that motion vector detected, thereby, producing interpolation pixels for building up the interpolation frame. Thus, the interpolation frame is produced by conducting that pixel interpolation upon all of the pixels within the interpolation frame. An example of producing this interpolation frame will be explained below, by referring to FIG. 5 attached herewith.

FIG. 5 shows the operations of the normal frame-rate converter unit 91, and there is shown an example of the case of conducting the frame interpolation by producing the interpolation frame with using the motion vector, which is obtained from two (2) pieces of frames in the front and the rear of the interpolation frame. The motion vector of the unit of pixel can be calculated, by obtaining a pair of pixels on the frames in the front and the rear locating at symmetric positions with respect to an interpolation pixel within that interpolation frame.

In this FIG. 5, x-axis indicates the horizontal direction, y-axis the vertical direction, and “t” the time direction of frames. Herein, it is assumed that a certain interpolation pixel is P03 within an interpolation frame #3′, and that the coordinates thereof (0,0). Search windows W2 and W4 are set up, for each of a front frame #2 and a rear frame #4, for indicating a search region or area of the motion vector. The search window W2 of the front frame #2 has the pixels, for example, within the front frame #2, spatially locating at the same position to the interpolation pixel P03, i.e., a size of seven (7) pixels in the x-axis direction around the pixel P02 locating at the intersection between the front frame #2 and an axis “L” and seven (7) pixels in the y-axis direction. The search window W4 of the rear frame #4 also has, in the similar manner, the pixels, for example, within the front frame #2, spatially locating at the same position to the interpolation pixel P03, i.e., a size of seven (7) pixels in the x-axis direction around the pixel P04 locating at the intersection between the front frame #4 and the axis “L” and seven (7) pixels in the y-axis direction, for example. However, it is assumed that the coordinates of the pixels P02 and P04 are (0,0).

Next, around the interpolation pixel P03 is set up a straight line, passing through the search window W2 of the front frame #2 and the search window W4 of the rear frame #4. Assuming that the coordinates of a pixel are (−3,3), locating at the left-upper end of the search window W2, for example, then the pixels within the search window W4, lying on the straight line connecting that pixel and the interpolation pixel P03, is the pixel locating at the right-lower end thereof, i.e., (3,−3) in the coordinates thereof. This straight line is set up or determined for all of pixels within the search windows W2 and W4. In this example, since the number of pixels of the search windows W2 and W is 7×7=49, then forty-nine (49) pieces of straight lines are determined, as the straight lines passing through the interpolation pixel P03.

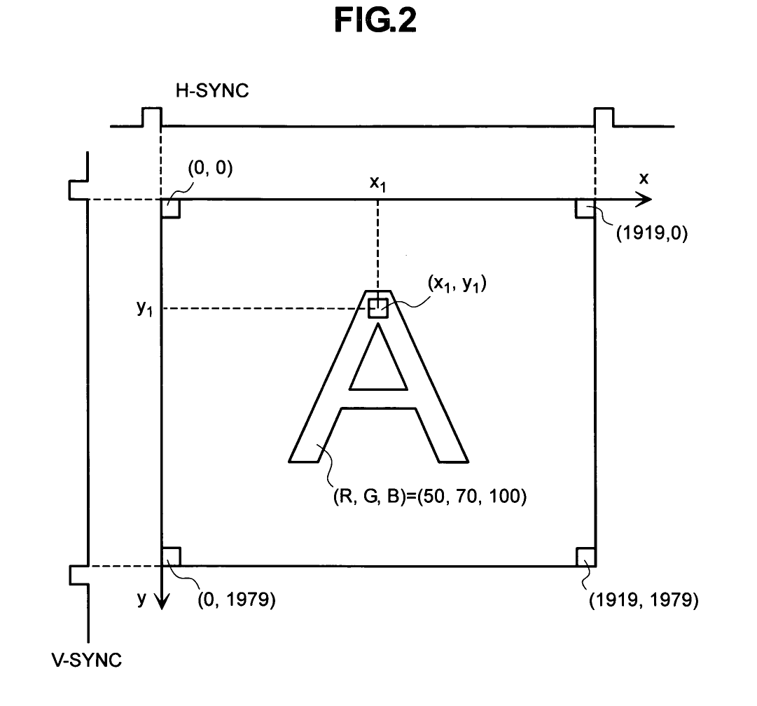

Next, for each one of the 49 pieces of straight lines, difference is calculated between the pixels within the search window W2 and the pixels within the search window W4, which the each strait line passes through. Herein, it is assumed that the difference is obtained of a brightness signal, for each pixel. A straight line having a pair, being the smallest in that difference, is determined to be the motion vector of the interpolation pixel P03. In the example shown in FIG. 2, it is assumed that a pair of the pixel P12 (being (2,2) in the coordinates thereof) within the search window W2, and the pixel P14 (being (−2,−2) in the coordinates thereof) within the search window W4, has the difference being the smallest. Accordingly, the straight line, connecting the pixel P12, the interpolation pixel P03 and the pixel P14, is determined to be the motion vector MV of that interpolation pixel P03. Namely, the pixel P12 within the front frame #2 moves in accordance with the direction indicated by the motion vector MV, i.e., passing through the pixel, being spatially equal to the interpolation pixel P03 within the interpolation frame #3, to the pixel P14 within the rear frame #4.

And, with using this motion vector MV, the interpolation pixel P03 is produced. For example, the interpolation pixel P03 is produced by calculating an averaged value between the pixel P12 within the front frame #2 and the pixel P14 within the rear frame #4, which the motion vector MV passes through. Also, the interpolation pixel P03 may be obtained though calculation indicated by the equation (Eq. 1) as follows:

P03=k·P02+(1−k)·P04 (However, k<1). (Eq. 1)

Herein, “k” motioned above is a weighting, i.e., a coefficient indicative of mixture ratio for both of the pixels, and for example, it may be determined depending on the time-sequential distance between the interpolation frame #3′ and the front frame #2, and that between the interpolation frame #3′ and the rear frame #4. In the first embodiment, since each of the time-sequential distance between the frames is equal to each other, then the averaged value is obtained between the two (2) pixels with determining k=0.5. Conducting such calculation upon all of the interpolation pixels of the interpolation frame #3′ enables to produce the interpolation frame #3′. The interpolation frame #3′ produces is memorized into a frame memory within the normal frame-rate converter unit 91, and it is read out at display timing of that interpolation frame #3′, to be outputted.

The interpolation frame outputted in this manner is inserted into frame lines of the video signal. With such insertion of this interpolation frame into the respective frames of the video signal, it is possible to achieve the conversion into 120 Hz, in case where the frame-rate of the input video signal is 60 Hz, for example. Also, if inserting one (1) piece of the interpolation frame into every two (2) pieces of continuous frames of the video signal, it is possible to convert the video signal into that of 90 Hz, in case when the frame rate of the input video signal is 60 Hz. Also, by replacing the repetitive frames included within the video signal of the 2-3 pull-down method, it is also possible make the motion smooth, while maintaining the frame rate to be 60 Hz.

In this manner, the normal frame-rate converter unit 91 detects the motion vector from plural numbers of frames included within the video signal, and upon basis of that motion vector, the interpolation frame is produced; thereby, achieving the frame-rate conversion. For that reason, if an OSD picture having no relationship with the video signal is included within the signal of frame, which is used as the basis for producing the motion vector, then a case may be caused where an end of the motion vector indicates a portion of that OSD picture while the other end thereof indicates a portion of the video signal. In such case, with such the processing as was mentioned above, each of the interpolation pixels within the interpolation frame comes to be weighing average between the OSD picture and the video signal. Thus, in such case, into the interpolation frame is mixed up with the OSD picture, having no relationship with the video signal, and a portion of that mixing may be seen, as noises.

For that reason, according to the present embodiment, as was mentioned above, the frame-rate conversion is conducted on the OSD picture, without detecting the motion vector thereon. Thus, there is provided an OSD area frame-rate converter unit 92 for conducting a process of increasing the number of frames by repeating the same picture. For this reason, in case when composing or synthesizing the OSD picture on the video signal, the OSD picture can be prevented from mixing into the area corresponding to the video signal of the interpolation frame. Namely, according to the present embodiment, it is characterized by that the method of the frame-rate conversion is exchanged between the region displaying the OSD picture and others than that, in particular, when composing or synthesizing the OSD picture on the video signal. Such the exchanging will be explained hereinafter.

In an exchanger unit 93, exchanging or changeover operation thereof is controlled by means of an output from the i-computer 20, wherein, for example, it is changed into an “A” terminal side shown in the figure, when the control signal from the i-computer 20 is “1”, so as to output the signal from the normal frame-rate converter unit 91, while when being “0”, it is exchanged into a “B” terminal side, so as to output the signal from the OSD area frame-rate converter unit 92. Further, the video signal outputted from this frame-rate converter unit 9, in particular, from that exchanger unit 93, thereafter, is inputted into the display panel unit 10 mentioned above, thereby to be displayed on the display screen thereof, and also, at the same time, the μ-computer 20 mentioned above, inputting a synchronization signal from the I/P conversion unit 5 of the picture quality corrector unit mentioned above through a synchronization detector unit 23, outputs the control signal, i.e., “1” or “0” to the exchanger unit 93, upon basis of this synchronization signal.

Next, explanation will be made, in details thereof, about the operation of the television receiver apparatus, the detailed structures of which was explained in the above, in particular, the operation of the frame-rate converter unit 9 after the OSD process, by referring to FIG. 2 attached herewith. However, in this FIG. 2, while showing the synchronization signal (H-SYNC) in the horizontal direction on the horizontal axis (i.e., the x-axis) while the synchronization signal (V-SYNC) in the vertical direction on the vertical axis (i.e., the y-axis), explanation will be made on the operations of the frame-rate conversion, in case when displaying a capital letter “A” of alphabets, as an example of the OSD signal, piling or lying on the video signal of one (1) piece of moving picture, for example.

As is apparent from this FIG. 2, the video signals including the moving picture therein are outputted, after being treated with the predetermined process within the picture quality corrector unit mentioned above, sequentially, upon a signal for each of the pixels of the one (1) piece of video signal, i.e., starting from the address (0,0) up to (1919,1979). On the other hand, the μ-computer 20, storing OSD data, including the characters and/or diagrams, etc., into the OSD data memory 21 thereof, outputs the data stored in the said memory 21 (for example, indicating a display color thereof, such as, (R,G,B)=(50,70,100), etc.) to the OSD processor unit 8 of the picture quality corrector unit mentioned above, when the address reaches to the position (i.e., address) where said OSD should be displayed (in the example shown in the figure, when reaching to (x1,y1)), and thereby displaying with lying the OSD display at desire (in the example shown in the figure, the capital letter “A” of alphabets) lying thereon. The, the μ-computer 20 mentioned above outputs the control signal “1” to the exchanger unit 93 of the above-mentioned frame-rate converter unit 9, when the video signal outputted from the said picture quality corrector unit is within a region (or an area) of the video signal, including the moving picture therein, and on the other hand, it outputs the control signal “0”, when the video signal outputted reaches to the region (or the area) of the video signal.

Thus, according to the embodiment mentioned above, among the video signal to be displayed, the frame interpolation is conducted upon the video signal, including the moving picture therein, by means of the normal frame-rate converter unit 91 of the frame-rate converter 9 mentioned above, and thereby displaying the output thereof on the display panel 10. On the other hand, among the video signal to be displayed, upon the OSD signal, including the characters and/or diagrams therein, are repeated the frame as the still picture, by the function of the OSD area frame-rate converter unit 92. With doing this, the still picture will not be drawn or influenced with, on a boundary portion between that OSD picture (i.e., being the moving picture), due to the frame-rate conversion, as was mentioned in the conventional technology, and it is possible to suppress the noises from generation on the boundary portion of the still picture.

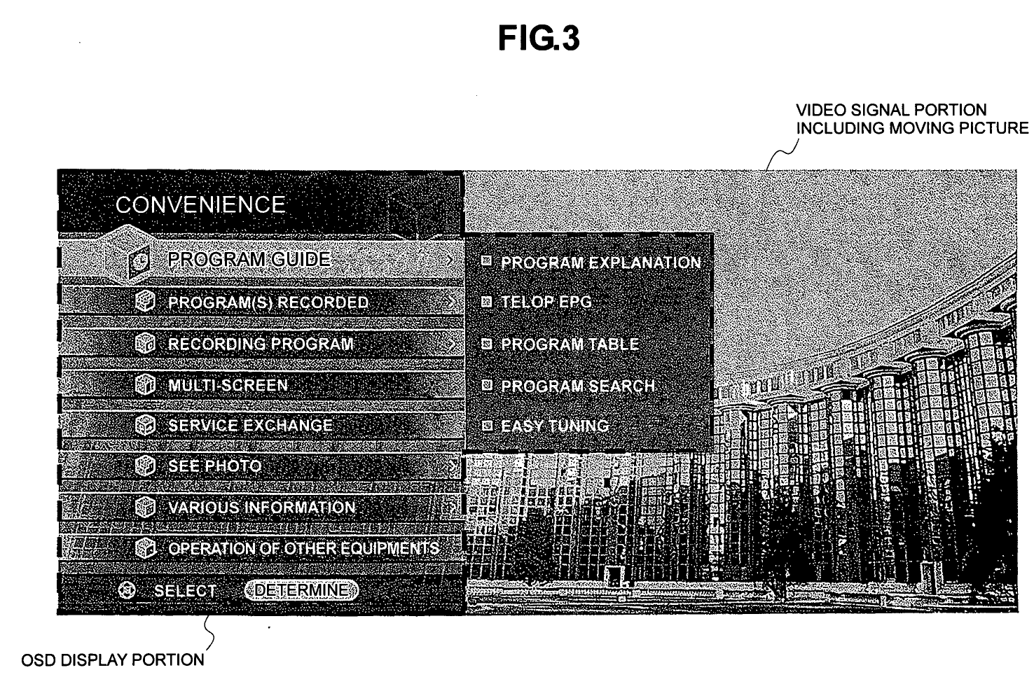

Further, FIG. 3 attached herewith shows an example of the display screen, including the OSD picture therein, which is obtained by the television receiver apparatus and the frame-rate converting method thereof, according the embodiment of the present invention mentioned above. Thus, as is apparent from this figure, it can be seen that a preferable display can be obtained without flickering due to the generation of noises, in particular, on a contour or outline portion of the OSD display portion, which is shown by broken lines in the figure.

On the other hand, the embodiment mentioned above is a preferable one, in particular, when the picture quality correct processor unit is built up in the form of the IC, including the exchanger unit 4, the I/P conversion unit 5, the scaling unit 6, the picture quality corrector unit 7 therein, and in addition thereto, the OSD process unit 8 for inserting the data (i.e., the OSD data) necessary for the OSD display into the video signal including the moving picture therein, as was mentioned above, and it is that of applying the frame-rate converter unit 9 therein, which builds in the exchanger unit 93, in addition to the normal frame-rate converter unit 91 and the OSD area frame-rate converter unit 92. However, the present invention should not be restricted only to this, and the following embodiment can be also made.

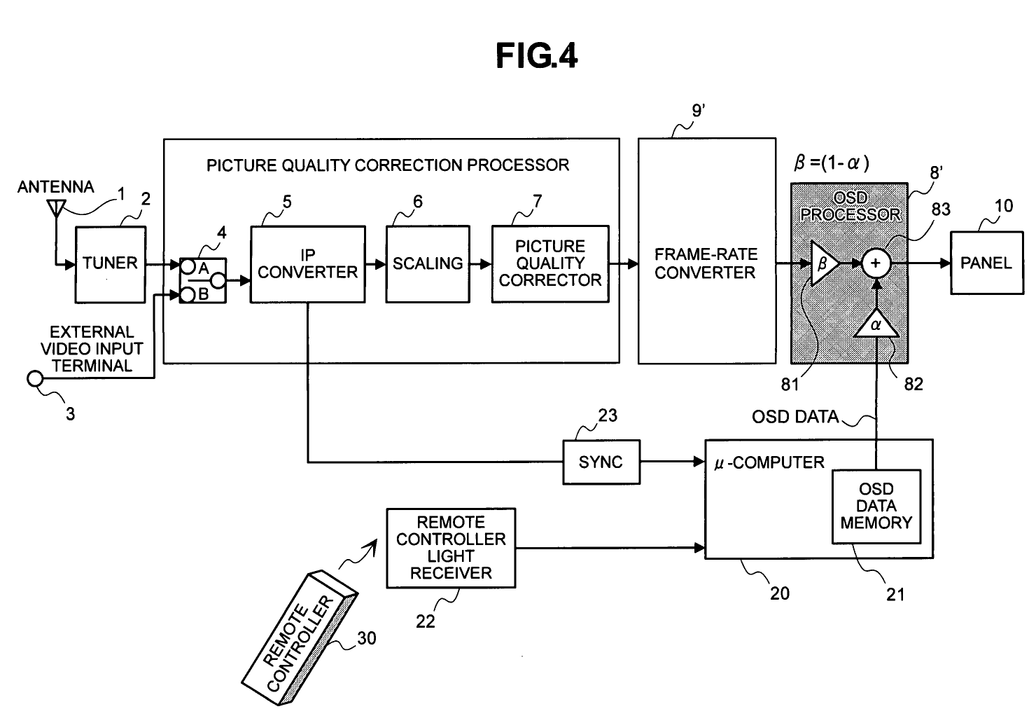

Following to the above, detailed explanation will be made hereinafter, on the television receiver apparatus, according to other embodiment of the present invention, by referring to FIG. 4 attached herewith. However, also in this figure, the reference numerals being same to those shown in FIG. 1 mentioned above indicates the constituent elements, being same or similar to those shown therein. And, in this other embodiment, as is apparent from the figure, the picture quality processor unit is built up with the exchanger unit 4, the I/P converter unit 5, the scaling unit 6 and the picture quality 7. And, upon the video signal supplied from the said picture quality processor unit is conducted the frame-rate conversion of video signal, by means of the frame-rate converter unit 9′, being constructed in the form of IC including only the normal frame-rate converter unit mentioned above, and thereby achieving the frame interpolation (i.e., moving picture frame interpolation).

Thereafter, within an OSD processor unit 8′ is inserted the data (i.e., the OSD data), necessary for the ISD (On Screen Display) for enabling introduction of the broadcast programs and/or the various functions and operations of the apparatus. In this OSD processor unit 8′, it is also same to the mentioned above, that the video signal from the picture quality corrector unit 7, amplitude of which is amplified by “β” times via that amplifier 81, and the ODS data (i.e., the still picture), amplitude of which is amplified by “α” times via that amplifier 82, are added by means of the adder 83 (i.e., laid on), in accordance with the relationship, β=1−α; 0≦α≦1). And, it is outputted from this OSD processor unit 8′, and the video signal added with the OSD display is displayed on the display panel 10. Further, in this example, it is also same to the mentioned above, that the μ-computer 20 has the OSD data memory 21 for storing the data (the OSD data) necessary for the OSD (On Screen Display), including the characters and diagrams, etc., and also inputs the optical control signal, such as, the infrared ray or the like, which is emitted from the remote controller 30 for controlling the television receiver apparatus, with receiving it on the remote controller light receiver unit 22, and thereby achieving the predetermined control. However, in this other embodiment, as is apparent from the figure, although increasing the number of parts thereof, but it includes only the normal frame-rate converter unit, as the frame-rate converter unit 9′, then it is possible to build up the frame-rate converter unit with relatively cheap prices; therefore, enabling to obtain an advantage that it is preferable from an economical viewpoint.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A television receiver apparatus, for interpolating a video signal including moving picture therein, and thereby displaying a picture together with an OSD picture thereon, comprising:
a picture quality corrector unit, which is configured to correct picture quality of an input video signal including the moving picture therein;
an ODS picture inserting unit, which is configured to insert the OSD picture into the video signal, including the moving picture therein, which is supplied from said picture quality corrector unit;
a frame-rate converter unit, which is configured to conduct a frame-rate conversion upon the video signal including the moving picture therein, being outputted from said OSD picture inserter unit, into which the OSD picture is inserted; and
a display unit, which is configured to display the video signal outputted from said frame-rate converter unit, wherein
said frame-rate converter unit executes a frame-rate conversion accompanying a moving picture frame interpolation therewith, upon the video signal including the moving picture therein within a screen of one (1) frame to be displayed, while it executes a frame-rate conversion accompanying no moving picture frame interpolation therewith, upon said OSD picture.

2. The television receiver apparatus, as described in the claim 1, wherein said frame-rate converter unit comprises a first converter unit, which is configured to execute said frame-rate conversion accompanying the moving picture frame interpolation therewith, a second converter unit, which is configured to execute said frame-rate conversion accompanying no moving picture frame interpolation therewith, and an exchanger unit, which is configured to selectively control an output from said first converter unit or an output from said second converter unit, corresponding to a picture portion including the moving picture therein on said screen of one (1) frame to be displayed and position information of said ODS picture.

3. The television receiver apparatus, as described in the claim 2, further comprises a controller unit, which is configured to control said exchanger unit of said frame-rate converter unit, wherein said controller unit comprises a memory memorizing the position information of said OSD picture.

4. A television receiver apparatus, for interpolating a video signal including moving picture therein, and thereby displaying a picture together with a still picture thereon, comprising:
a picture quality corrector unit, which is configured to correct picture quality of an inputted video signal, including the moving picture therein;
a frame-rate converter unit, which is configured to conduct a frame-rate conversion upon the video signal including the moving picture therein, being outputted from said picture quality corrector unit; and
a display unit, which is configured to display the video signal outputted from said frame-rate converter unit, further comprising
an OSD picture inserter unit, which is configured to insert an OSD picture into a portion of the video signal including the moving picture therein, being outputted from said frame-rate converter unit, into which the still picture is inserted.

5. A frame-rate converting method within a television receiver apparatus for interpolating a video signal including moving picture therein, and thereby displaying a picture together with a still picture thereon, comprising the following steps of:
conducting a picture quality correction for correcting picture quality of an input video signal including moving picture therein;
inserting an OSD picture into the video signal including the moving picture therein, upon which the picture quality correction is conducted; and
conducting a frame-rate conversion upon the video signal including the moving picture therein, into which said OSD picture is inserted, wherein
a frame-rate conversion accompanying a moving picture frame interpolation therewith is conducted upon the video signal including the moving picture therein within a screen of one (1) frame to be displayed, while a frame-rate conversion accompanying no moving picture frame interpolation therewith is conducted upon said OSD picture.

6. A frame-rate converting method within a television receiver apparatus for interpolating a video signal including moving picture therein, and thereby displaying a picture together with a still picture thereon, comprising the following steps of:
conducting a picture quality correction for correcting picture quality of an input video signal including moving picture therein;
conducting a frame-rate conversion upon said video signal including the moving picture therein, upon which said picture quality correction is conducted; and
inserting an OSD picture into the video signal including the moving picture therein, upon which said frame-rate conversion is conducted, whereby displaying the video signal including the moving picture therein, into which said OSD picture is inserted, on a display unit.

7. A television receiver apparatus, comprising:
an OSD inserter unit, which is configured to insert an OSD picture into an input video signal including a moving picture therein;
a frame-rate converter unit, which is configured to produce an interpolation frame by detecting a motion vector from a plural number of frames included in said video signal, into which said OSD picture is inserted, and conduct a frame-rate conversion by inserting said interpolation frame into frame lines of the input video signal, thereby conducting a frame-rate conversion; and
a display unit, which is configured to display the signal from said frame-rate converter unit thereon, wherein
said frame-rate converter unit conducts the frame-rate conversion process without detecting said motion vector, within a region of said OSD picture.
